(19) United States
(12) Patent Application Publication
(10) Pub. No.: US 2026/0061840 A1
(43) Pub. Date: Mar. 5, 2026

(54) SYSTEM AND METHOD TO PERSONALIZE PHOTO SHARING

(71) Applicant: GM Global Technology Operations LLC, Detroit, MI (US)

(72) Inventors: Chuan Li, Troy, MI (US); Esther Anderson, Canton, MI (US); Fan Bai, Ann Arbor, MI (US); Jace C. Stokes, Highland, MI (US); Travis Scott Hester, Rochester Hills, MI (US)

(73) Assignee: GM Global Technology Operations LLC, Detroit, MI (US)

(21) Appl. No.: 18/819,068

(22) Filed: Aug. 29, 2024

(51) Int. Cl. B60K 35/10; B60K 35/22; G06V 40/16

(52) U.S. Cl. CPC B60K 35/10; B60K 35/22; G06V 40/172

(57) ABSTRACT

A system and method of personalized photo sharing includes receiving image data captured by a sensor system, the image data including an object approaching a vehicle, identifying the object in the image data as a user of the vehicle, receiving a user context of the user of the vehicle, and receiving a vehicle context of the vehicle. The system and method also include determining, based on the vehicle context of the vehicle, that photo sharing is appropriate, retrieving, based on the user context and the vehicle context, a photo associated with a user account of the user, and displaying the photo associated with the user account on a screen in communication with data processing hardware.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to personalized photo sharing within the user interface of a vehicle. Generally, when a user enters the vehicle, there is a short amount of time before the user interface is taken over by vehicle applications such as CarPlay®, Android-Auto®, etc. However, in an ever-connected world, users are more and more interested in having personalized experiences from their connected devices.

Accordingly, rather than displaying a blank screen on the user interface, the user may benefit from a more personalized experience that learns from the movements and context of the user and infers what would be useful or interesting for the user to see. For example, photo sharing can be used to remind the user that a particular task (e.g., get lunch, pick up at daycare, etc.) needs to be done, and/or to highlight celebratory highlights such as birthdays and anniversaries. However, accurately recognizing the user with sufficient time to select a relevant photo may be challenging with a network of cameras with different viewpoints. Moreover, photos should only be shared when it is a safe time to do so to prevent distracting the user. Further, personalizing the photo and/or filters on the photo may be challenging without a high-quality method of tracking the movements and network of the user.

### SUMMARY

One aspect of the disclosure provides a computer-implemented method for personalizing photo sharing that when executed on data processing hardware causes the data processing hardware to perform operations that include receiving image data captured by a sensor system, the image data including an object approaching a vehicle, and identifying the object in the image data as a user of the vehicle. The operations also include receiving a user context of the user of the vehicle, receiving a vehicle context of the vehicle, and determining, based on the vehicle context, that photo sharing is appropriate. The operations further include retrieving, based on the user context and the vehicle context, a photo associated with a user account of the user, and displaying the photo associated with the user account on a screen in communication with the data processing hardware.

Implementations of the disclosure may include one or more of the following optional features. In some implementations, displaying the photo associated with the user account on the screen in communication with the data processing hardware includes applying a filter to the photo based on the user context. In some examples, the user context includes a knowledge scope. In these examples, the knowledge scope may include one of time-irrelevant, slow-changing, or time-sensitive. Additionally or alternatively, retrieving, based on the user context, the photo associated with the user account of the user may include selecting the photo based on the knowledge scope of the user context.

In some implementations, determining, based on the vehicle context, that photo sharing is appropriate includes determining that the vehicle context indicates one or more of that the vehicle is parked, that the vehicle is connected to a network, that the screen in communication with the data processing hardware is on, or that the screen in communication with the data processing hardware is available. In some examples, the sensor system includes a plurality of cameras. In these examples, identifying the object in the image data as the user of the vehicle may include generating, for each camera of the plurality of cameras, a respective confidence that the object in the image data is the user of the vehicle. Here, identifying the object in the image data as the user of the vehicle may include determining that the respective confidence for a camera of the plurality of cameras exceeds a threshold. In some implementations, identifying the object in the image data as the user of the vehicle includes recognizing the object as a registered user.

Another aspect of the disclosure provides a system for personalized photo sharing that includes data processing hardware and memory hardware in communication with the data processing hardware. The memory hardware stores instructions that when executed by the data processing hardware cause the data processing hardware to perform operations that include receiving image data captured by a sensor system, the image data including an object approaching a vehicle, and identifying the object in the image data as a user of the vehicle. The operations also include receiving a user context of the user of the vehicle, receiving a vehicle context of the vehicle, and determining, based on the vehicle context, that photo sharing is appropriate. The operations further include retrieving, based on the user context and the vehicle context, a photo associated with a user account of the user, and displaying the photo associated with the user account on a screen in communication with the data processing hardware.

This aspect may include one or more of the following optional features. In some implementations, displaying the photo associated with the user account on the screen in communication with the data processing hardware includes applying a filter to the photo based on the user context. In some examples, the user context includes a knowledge scope. In these examples, the knowledge scope may include one of time-irrelevant, slow-changing, or time-sensitive. Additionally or alternatively, retrieving, based on the user context, the photo associated with the user account of the user may include selecting the photo based on the knowledge scope of the user context.

In some implementations, determining, based on the vehicle context, that photo sharing is appropriate includes determining that the vehicle context indicates one or more of that the vehicle is parked, that the vehicle is connected to a network, that the screen in communication with the data processing hardware is on, or that the screen in communication with the data processing hardware is available. In some examples, the sensor system includes a plurality of cameras. In these examples, identifying the object in the image data as the user of the vehicle may include generating, for each camera of the plurality of cameras, a respective confidence that the object in the image data is the user of the vehicle. Here, identifying the object in the image data as the user of the vehicle may include determining that the respective confidence for a camera of the plurality of cameras exceeds a threshold. In some implementations, identifying the object in the image data as the user of the vehicle includes recognizing the object as a registered user.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for personalized photo sharing.

FIG. 2 is a schematic view of example components of the system of FIG. 1.

FIG. 3 is an example user interface displaying a personalized photo using the system of FIG. 1.

FIG. 4 is a flowchart of a user's trajectory as it approaches the system of FIG. 1.

FIG. 5 is a flowchart of an example arrangement of operations for a method of determining when personalized photo sharing is appropriate.

FIG. 6 is a schematic view of example components of the system of FIG. 1.

FIG. 7 is a flowchart of an example arrangement of operations for a method of personalized photo sharing.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

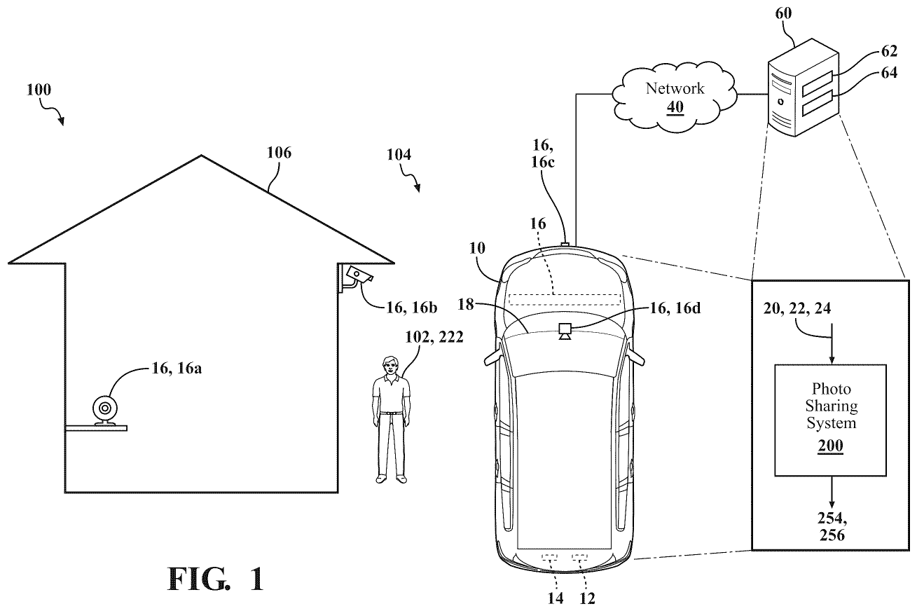

Referring to FIG. 1, in some implementations, a system 100 includes a vehicle 10 in communication with a remote system 60 via a network 40 (e.g., via wired or wireless communication). The vehicle 10 and/or the remote system 60 execute a photo sharing system 200. Briefly, and as described in further detail below, the photo sharing system 200 is configured to apply a probabilistic approach to improve user identification of a user 222 using multiple camera inputs, determine, based on the vehicle 10, whether photo sharing is appropriate, and select a photo 254 and/or filters 256 for the photo 254 by inferring what the user 222 would like to see. Notably, by inferring the appropriate photo 254 for the particular user 222 that is approaching the vehicle 10 and which effects to apply to the photo 254, the photo sharing system 200 provides a highly personalized vehicle experience for the user 222.

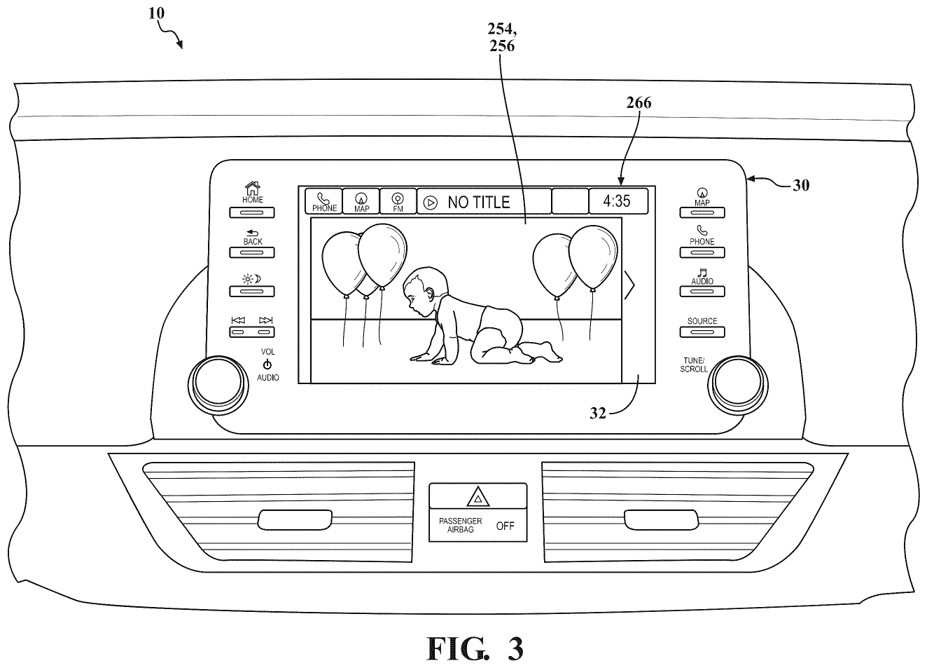

In the example shown, the photo sharing system 200 is implemented within the vehicle 10. However, the photo sharing system 200 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 12 to perform operations. The vehicle 10 further includes a user interface 30 (FIG. 3) having a screen 32 configured to display photos 254 selected by the photo sharing system 200. The user interface 30 may be implemented in the infotainment system of the vehicle 10, however it should be appreciated the user interface 30 may be implemented in other computing devices (e.g., computing devices in communication with the vehicle 10), such as, without limitation, a head-up display, a smart phone, tablet, smart display, desktop/laptop, smart watch, smart appliance, or smart glasses/headset. The vehicle 10 also includes an image system 16, 16a-16d (e.g., one or more cameras) configured to capture image data 20 in an environment 104 of the vehicle 10. For example, the image data 20 may include one or more data fragments including an object 102 approaching the vehicle 10. Here, the one or more cameras 16a-16d may continuously or periodically collect image data 20 of the environment of the vehicle 10 and provide it as input to the photo sharing system 200 for further downstream processing (e.g., object detection, user recognition, etc.).

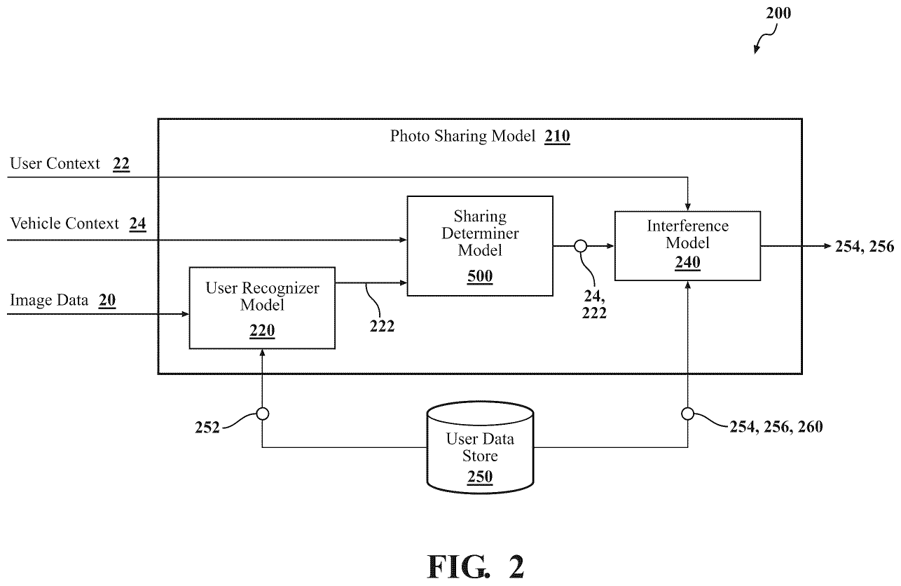

The remote system 60 (e.g., server, cloud computing environment) also includes data processing hardware 62 and memory hardware 64 storing instructions that when executed on the data processing hardware 62 cause the data processing hardware 62 to perform operations. In some implementations, execution of the photo sharing system 200 is shared across the vehicle 10 and/or the remote system 60. As described in greater detail below with reference to FIGS. 2 and 4-6, the photo sharing system 200 executes a photo sharing model 210 including a user recognizer model 220, a sharing determiner model 500, and an inference model 240. In some implementations, the photo sharing model 210 has access to a user data store 250 that records/stores photo identification 252 (e.g., created during an account registration process) of the user 222, photos 254 belonging to the user 222, filters 256 for the photos 254, and/or previous user contexts 22 of the user 222. The user data store 250 may be stored on any one of the memory hardware 24, 64. The photo sharing model 210 is configured to receive image data 20 of the environment 104 of the vehicle 10, user context 22 of the user 222, and vehicle context 24 of the vehicle 10 and, based on the user context 22 and the vehicle context 24, display a photo 254 associated with a user account of the user 222 on the screen 32 of the user interface 30.

With reference to FIGS. 1, 2, and 4, the user recognizer model 220 may be configured to receive image data 20 captured by the image system 16. In particular, the image system 16 may include an indoor camera 16a located inside of a building 106 in which the user 222 is located, such as an appliance camera or a security system, an outdoor camera 16b mounted to an exterior surface of the building 106, such as a security camera, a vehicle exterior camera 16c mounted to the exterior surface of the vehicle 10 and configured to capture the environment 104 from a perspective of the vehicle 10, and a cabin camera 16d configured to capture the interior of the vehicle 10, such as eye movements and position of the user 222. Here, the cabin camera 16d may be positioned for optimal viewing of the user 222 and confirmation of the identity of the user 222. However, identifying the user 222 before the user 222 enters the cabin of the vehicle 10 is critical to ensure timely display of the photos 254 before additional applications (e.g., CarPlay®, Android Auto®, etc.) take over control of the user interface 30. As such, the photo sharing system 200 relies on the cameras 16a-16c to identify the user 222 before the user 222 enters the cabin of the vehicle 10. Due to each of the cameras 16a-16c of the image system 16 having different viewpoints that are not optimal viewing angles for identifying the user 222, each camera 16a-16c alone may be unable to identify the user 222. In other words, each of the cameras 16a-16c may collect image data 20 including one or more fragments including an object 102, however the cameras 16a-16c may be unable to individually recognize/identify the object 102 as the user 222. It should be appreciated that the image system 16 may include any number of cameras 16 that collect image data 20 for identifying the user 222 depending on the trajectory of the user's approach toward the vehicle 10.

Continuing with the example, as the user recognizer model 220 receives the image data 20 from the respective cameras 16-16c, the user recognizer model 220 continually calculates a probability that the object 102 in the image data 20 is a user 222 of the vehicle 10. For example, the user 222 may have, during an initialization process of the vehicle 10, registered a user account including a photo identification 252 of the user 222. As used herein, the photo identification 252 of the user 222 may refer to a higher order feature representation (e.g., an embedding) of features of the face of the user 222 that the user recognizer model 220 compares to the image data 20 when determining whether the object 102 represents the user 222. For example, the user recognizer model 220 may extract features from the object 102 of the image data 20 and attempt to align the extracted features of the object 102 with one or more of the photo identifications 252 in the user data store 250. When an alignment between the extracted features of the object 102 and a photo identification 252 in the user data store 250 exceeds a probability threshold, the user recognizer model 220 may identify/recognize the object 102 as the user 222.

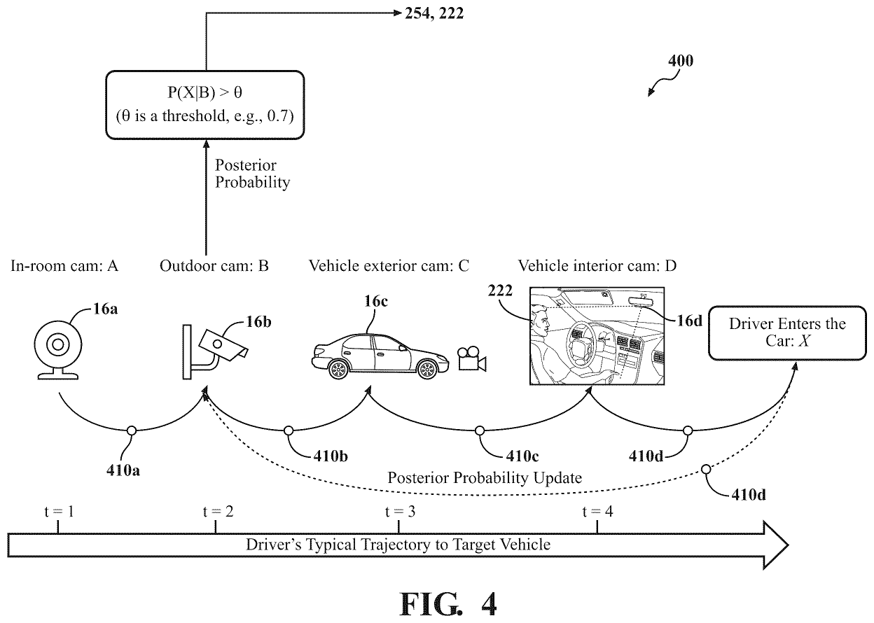

With particular reference to FIGS. 1 and 4, the user recognizer model 220 may perform user recognition on the image data 20 using a probabilistic method that builds on the incoming image data 20 collected by the cameras 16 that the user 222 previously passed. Here, and as noted above, each of the cameras 16a-16c may be unable to independently recognize the object 102 as the user 222 and, as such, the cameras 16a-16c may compensate for one another by the probabilistic method. As the object 102 approaches the vehicle 10, and as the object 102 passes by each camera 16, the user recognizer model 220 may perform user recognition on the object 102 and generate a respective confidence 410 that the object 102 is the user 222 of the vehicle 10. When the respective confidence 410 of a particular camera 16 exceeds a threshold confidence, the user recognizer model 220 may recognize the object 102 as the user 222 and initiate/trigger the models (i.e., the sharing determiner model 500 and the inference model 240) to begin further processing for photo sharing for the recognized user 222 approaching the vehicle 10.

Referring to FIG. 4, an example flowchart 400 of a trajectory of an object 102 as it moves through an environment 104 and approaches a vehicle 10 is shown. Here, the object 102 may pass by the indoor camera 16a, the outdoor camera 16b, the vehicle exterior camera 16c, and the vehicle cabin camera 16d. At each timestep, and for each camera 16a-16c, the user recognizer model 220 may receive the image data 20 from each respective camera 16 and calculate the probability (i.e., the confidence 410) that the image data 20 including the object 102 corresponds to the registered user 222.

In the example, at t=1, the registered user 222 may leave a building 106 that houses the indoor camera 16a. The user recognizer model 220 may receive the image data 20 detected by the indoor camera 16a and calculate a confidence 410a that the object 102 in the image data 20 is the registered user 222. If the confidence 410a of the indoor camera 16a does not exceed the threshold confidence, then at t=2, when the registered user 222 passes the outdoor camera 26b, the user recognizer model 220 may receive the image data 20 detected by the outdoor camera 16b, as well as the confidence 410a of the indoor camera 16a, and calculate a confidence 410b that the object 102 in the image data 20 is the registered user 222. Here, the user recognizer model 220 conditions the confidence 410b on the confidence 410a calculated for the indoor camera 16a. If the confidence 410b of the outdoor camera 16b does not exceed the threshold confidence, then at t=3, when the registered user 222 approaches the vehicle exterior camera 16c mounted on the outside of the vehicle 10, the user recognizer model 220 may receive the image data 20 detected by the vehicle exterior camera 16c, as well as the respective confidences 410a, 410b of the cameras 16a, 16b, and calculate a confidence 410c that the object 102 in the image data 20 is the registered user 222. Here, the user recognizer model 220 conditions the confidence 410c on the respective confidences 410a, 410b calculated for the previous cameras 16a, 16b. If the confidence 410c of the vehicle exterior camera 16c does not exceed the threshold confidence, then at t=4, when the registered user 222 enters the cabin of the vehicle 10, the user recognizer model 220 may receive the image data 20 detected by the vehicle interior camera 16d, as well as the respective confidences 410a-410c of the cameras 16a-16b and calculate a confidence 410d that the object 102 in the image data 20 is the registered user 222.

In some implementations, because the vehicle interior camera 16d is optimally positioned to recognize the registered user 222, the user recognizer model 220 may use the respective confidence 410d associated with the vehicle interior camera 16d to perform a posterior probability update of the probability models used for future recognitions of users 222 of the vehicle. For example, the user recognizer model 220 may, based on the confirmation by the vehicle interior camera 16d, update the conditional probability of the outdoor camera 16b. In the example shown in FIG. 4, the respective confidence 410d of the outdoor camera 16b may exceed the confidence threshold (e.g., 0.7) and, as such, the user recognizer model 220 triggers the photo sharing model 210 to proceed to determining whether photo sharing is appropriate for the recognized particular user 222.

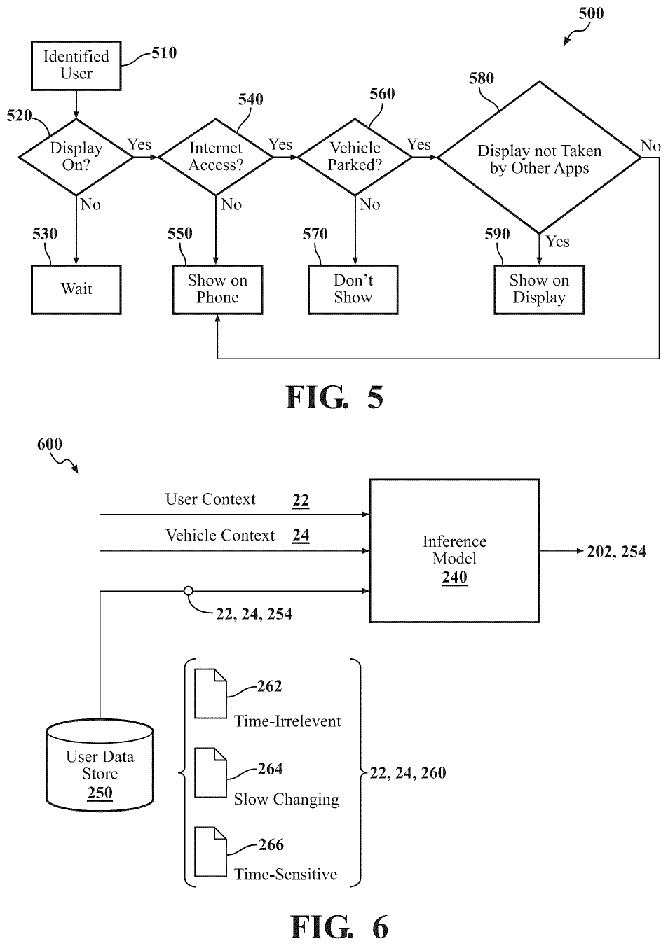

Referring to FIGS. 2 and 5, the sharing determiner model 500 is configured to receive the identity of the recognized user 222, as well as the vehicle context 24 of the vehicle 10, and determines, based on the vehicle context 24, whether photo sharing is appropriate. In other words, the sharing determiner model 500 leverages the vehicle context 24 of the vehicle 10 to determine whether to show a photo 254 to the user 222. As used herein, the vehicle context 24 may refer to any state or system of the vehicle 10 whether active or inactive such as, without limitation, the connectivity of the vehicle 10, the battery life and/or fuel level of the vehicle 10, the gear the vehicle 10 is in, and/or whether other applications are currently controlling systems of the vehicle 10. With particular reference to FIG. 5, the sharing determiner model 500, at operation 510, receives the identity of the recognized user 222, thereby triggering the sharing determiner model 500 to perform operations. At operation 520, the sharing determiner model 500 determines whether the vehicle context indicates that the user interface 30 is powered on. When the vehicle context 24 indicates that the user interface 30 of the vehicle 10 is not currently powered on, at operation 530, the sharing determiner model 500 enters a waiting/standby mode.

If the vehicle context 24 identifies that the user interface 30 is powered on, the sharing determiner model 500 proceeds to operation 540, which determines whether the vehicle context 24 indicates that the vehicle 10 has access to the internet (e.g., the network 40). At operation 550, when the vehicle context 24 indicates that the vehicle 10 is not connected to the network 40, the photo sharing model 210 may show a photo 254 on a mobile device (not shown) associated with the user 222. Conversely, if the sharing determiner model 500 determines that the vehicle context 24 indicates that the vehicle 10 is connected to the network 40, at operation 560, the sharing determiner model 500 determines whether the vehicle context 24 indicates that the vehicle 10 is parked. When the vehicle context 24 indicates that the vehicle 10 is not parked, at operation 570, the sharing determiner model 500 determines that photo sharing is not appropriate, as it would possibly distract the user 222 of the vehicle 10.

Conversely, when the vehicle context 24 indicates that the vehicle 10 is parked, the sharing determiner model 500 proceeds to operation 580, which determines whether the vehicle context 24 indicates that the user interface 30 is not currently taken by other applications (i.e., is available). At operation 590, when the vehicle context 24 indicates that the user interface 30 is currently being used by other applications of the vehicle 10 that take priority, the photo sharing model 210 may show the photo 254 on the mobile device associated with the user 222. Conversely, when the vehicle context 24 indicates that the user interface 30 is not currently being used by other applications of the vehicle 10, the sharing determiner model 500 determines that photo sharing is appropriate and, at operation 590 proceeds to select a photo 254 and display the photo 254 in the user interface 30.

In some implementations, the sharing determiner model 500 leverages additional context from the user 222 when determining whether photo sharing is appropriate. For example, the position of the user 222 relative to the user interface 30. Here, if the user 222 is seated in a rear passenger seat (e.g., a third row), the user 222 may not have a view of the user interface 30. Based on the position of the user 222, the sharing determiner model 500 may determine that delivering the photo 254 to a mobile device of the user 222 rather than the user interface 30 is appropriate. Moreover, in some implementations, the additional context from the user 222 may include whether the user 222 is asleep and not capable of viewing the photo 254. In these examples, the sharing determiner model 500 may determine that photo sharing is not appropriate because the user 222 is not awake to view the photo 254. In these implementations, onboard intelligence algorithms of the vehicle 10 may detect the additional context of the user 222.

After the sharing determiner model 500 determines that photo sharing is appropriate based on the vehicle context 24 of the vehicle 10, the inference model 240 may retrieve, based on a user context 22 of the registered user 222 and the vehicle context 24, a photo 254 associated with the user account of the user 222. Here, the user context 22 may refer to known facts such as a current state, location, or environment of a user 222, as well as historical routines of the user 222 such as where the user 222 has taken the vehicle 10 and/or what the user 222 has done in particular locations. The inference model 240 receives the user context 22 and the vehicle context 24, and infers, based on the user context 22 and the vehicle context 24, which photo 254 of the user's account to show to the user 222 via the user interface 30.

With reference to FIG. 6, in some implementations, the user data store 250 stores the historical user context 22 and/or vehicle context 24 associated with the account of the user 222 as a knowledge scope 260. The knowledge scope 260 may include the historical user context 22 and vehicle context 24 of the user account encoded in a knowledge graph as ontologies using semantic web terms. As shown, the knowledge scope 260 may include time-irrelevant knowledge 262, slow-changing knowledge 264, and time-sensitive knowledge 266. Time-insensitive knowledge 262 may refer to information such as a relationship between the user 222 and other users (e.g., friends or family). For example, the registered user 222 may be Bob, and time-irrelevant knowledge 262 may be that the user 222 Bob has a wife named Sheila and a daughter named Colleen. Slow-changing knowledge 264 may refer to events that are relatively static such as when the registered user 222 Bob typically eats lunch, the location of Bob's office, or a location of his daughter Colleen's school. Time-sensitive knowledge 266 may generally refer to specific schedules of the user 222 Bob such as, without limitation, what time that Bob spends at his office, or what time Bob usually picks up his daughter Colleen from school. Notably, while the inference model 240 may always base its inference of which photo 254 of the user account to select on the time-irrelevant knowledge 262 and the slow-changing knowledge 264, the inference model 240 may not apply the time-sensitive knowledge 266 outside of the temporal windows in which it is relevant. For instance, if the school pickup for Colleen is between 4 and 5 pm, the inference model 240 may disregard the time-sensitive knowledge 266 of reminding Bob to pick up Colleen when it is outside the hours of 4 and 5 pm, and only apply the time-irrelevant knowledge 262 and the slow-changing knowledge 264, and further apply time-sensitive knowledge 266 only relevant to the current time-window, different from the school-pickup time-window.

In some cases, the knowledge graph of the knowledge scope 260 may be developed from various data streams. For example, the knowledge scope 260 may align and merge data streams from proprietary knowledge bases such as ontology updating application programming interfaces, crawlers from service sites, private fact updates (e.g., birthdays, weddings, graduations, etc.) collected by customized interfaces such as websites and/or applications designed by the maker of the vehicle 10, and/or reminder and calendar information stored in event recording applications associated with the user 222. For example, child drop-off and child-pick up may be encoded as ontologies in the knowledge graph using temporal vocabulary (e.g., 5 pm). Where the user 222 has traveled may be monitored by a trace of the vehicle 10 and encoded in the knowledge graph. Similarly, points of interest (e.g., home, coffee shops, gyms) may be encoded in the knowledge graph using GPS and/or map data. Passengers of the vehicle 10 may be determined by the interior camera 16d and encoded in the knowledge graph as well to record who the user 222 typically travels with in the vehicle 10.

With continued reference to FIGS. 2 and 3, the inference model 240 receives the user context 22 including the knowledge scope 260 and the vehicle context 24 and retrieves the photo 254 associated with the user account of the user 222, and displays the photo 254 on the screen 32 in communication with the data processing hardware 12, 62. In some implementations, the inference model 240 additionally retrieves a filter 256 for the photo 254. Here, the filter 256 for the photo 254 may be selected based on the user context 22 (e.g., the knowledge scope 260). For example, the inference model 240 may apply rule-based inference to determine not only which photo 254 to retrieve, but which filter 256 to apply to the photo 254, if any.

With particular reference to FIG. 2, the vehicle context 22 may indicate that the instant day is the birthday of the user 222 Bob's daughter Colleen (i.e., time-irrelevant knowledge 262), that the user 222 Bob is currently in the vehicle 10, and that it is 4:35 pm (i.e. within the time-sensitive knowledge 266 of school pickup for Colleen between 4 and 5 pm), the inference model 240 may determine that the rule is satisfied to show a photo 254 of Colleen on the screen 32 of the user interface 30 and apply a birthday filter 256 to the photo 254 to remind the user 222 Bob to pick Colleen up from school. As shown, the filter 256 includes balloons overlaying a photo 254 of the user 222 Bob's daughter Colleen crawling. It should be appreciated that while a birthday rule is described herein, the inference model 240 may apply any multitude of rules to either remind the user 222 of something such as, for example when to stop for lunch by displaying a photo 254 of food in the user interface 30, as well as to simply bring joy to the user 222 by showing a photo 254 that is relevant to the user context 22 of the user 222.

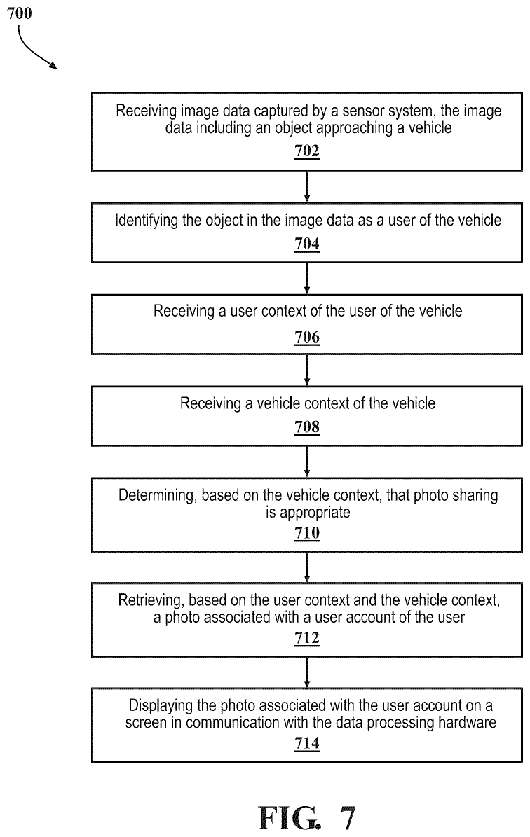

FIG. 7 includes a flowchart of an example arrangement of operations for a method 700 for personalized photo sharing in a screen 32 of a display 30 in a vehicle 10. Data processing hardware (e.g., data processing hardware 12, 62 of FIG. 1) may execute instructions stored on memory hardware (e.g., memory hardware 14, 64 of FIG. 1) to perform the example arrangement of operations for the method 700. At operation 702, the method 700 includes receiving image data 20 captured by a sensor system 16 of a vehicle 10. Here, the image data 20 includes an object 102 approaching the vehicle 10.

At operation 704, the method 700 also includes identifying the object 102 in the image data 20 as a user 222 of the vehicle 10. The method 700 also includes, at operation 706, receiving a user context 22 of the user 222 of the vehicle 10. At operation 708, the method 700 also includes receiving a vehicle context 24 of the vehicle 10.

At operation 710, the method 700 further includes determining, based on the vehicle context 24, that photo sharing is appropriate. At operation 712, the method 700 also includes retrieving, based on the user context 22 and the vehicle context 24, a photo 254 associated with a user account of the user 222. The method 700 also includes, at operation 714, displaying the photo 254 associated with the user account of the user 222 on a screen 32 in communication with the data processing hardware 12, 62.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving image data captured by a sensor system, the image data including an object approaching a vehicle;
identifying the object in the image data as a user of the vehicle;
receiving a user context of the user of the vehicle;
receiving a vehicle context of the vehicle;
determining, based on the vehicle context, that photo sharing is appropriate;
retrieving, based on the user context and the vehicle context, a photo associated with a user account of the user; and
displaying the photo associated with the user account on a screen in communication with the data processing hardware.

2. The method of claim 1, wherein displaying the photo associated with the user account on the screen in communication with the data processing hardware comprises applying a filter to the photo based on the user context.

3. The method of claim 1, wherein the user context comprises a knowledge scope.

4. The method of claim 3, wherein the knowledge scope comprises one of time-irrelevant, slow-changing, or time-sensitive.

5. The method of claim 3, wherein retrieving, based on the user context, the photo associated with the user account of the user comprises selecting the photo based on the knowledge scope of the user context.

6. The method of claim 1, wherein determining, based on the vehicle context, that photo sharing is appropriate comprises determining that the vehicle context indicates one or more of:
that the vehicle is parked;
that the vehicle is connected to a network;
that the screen in communication with the data processing hardware is on; or
that the screen in communication with the data processing hardware is available.

7. The method of claim 1, wherein the sensor system comprises a plurality of cameras.

8. The method of claim 7, wherein identifying the object in the image data as the user of the vehicle comprises generating, for each camera of the plurality of cameras, a respective confidence that the object in the image data is the user of the vehicle.

9. The method of claim 8, wherein identifying the object in the image data as the user of the vehicle comprises determining that the respective confidence for a camera of the plurality of cameras exceeds a threshold.

10. The method of claim 1, wherein identifying the object in the image data as the user of the vehicle comprises recognizing the object as a registered user.

11. A system comprising:
data processing hardware; and
memory hardware in communication with the data processing hardware, the memory hardware storing instructions that when executed on the data processing hardware cause the data processing hardware to perform operations comprising:
receiving image data captured by a sensor system, the image data including an object approaching a vehicle;
identifying the object in the image data as a user of the vehicle;
receiving a user context of the user of the vehicle;
receiving a vehicle context of the vehicle;
determining, based on the vehicle context, that photo sharing is appropriate;
retrieving, based on the user context and the vehicle context, a photo associated with a user account of the user; and
displaying the photo associated with the user account on a screen in communication with the data processing hardware.

12. The system of claim 11, wherein displaying the photo associated with the user account on the screen in communication with the data processing hardware comprises applying a filter to the photo based on the user context.

13. The system of claim 11, wherein the user context comprises a knowledge scope.

14. The system of claim 13, wherein the knowledge scope comprises one of time-irrelevant, slow-changing, or time-sensitive.

15. The system of claim 13, wherein retrieving, based on the user context, the photo associated with the user account of the user comprises selecting the photo based on the knowledge scope of the user context.

16. The system of claim 11, wherein determining, based on the vehicle context, that photo sharing is appropriate comprises determining that the vehicle context indicates one or more of:
that the vehicle is parked;
that the vehicle is connected to a network;
that the screen in communication with the data processing hardware is on; or
that the screen in communication with the data processing hardware is available.

17. The system of claim 11, wherein the sensor system comprises a plurality of cameras.

18. The system of claim 17, wherein identifying the object in the image data as the user of the vehicle comprises generating, for each camera of the plurality of cameras, a respective confidence that the object in the image data is the user of the vehicle.

19. The system of claim 18, wherein identifying the object in the image data as the user of the vehicle comprises determining that the respective confidence for a camera of the plurality of cameras exceeds a threshold.

20. The system of claim 11, wherein identifying the object in the image data as the user of the vehicle comprises recognizing the object as a registered user.
